(19) United States
(12) Patent Application Publication
(10) Pub. No.: US 2026/0350697 A1
(43) Pub. Date: Nov. 5, 2026

(54) SYSTEMS AND METHODS FOR DECISION SUPPORT FOR TRADING CRYPTOCURRENCY

(71) Applicants: The Florida International University Board of Trustees, Miami, FL (US); The Board of Regents of the University of Oklahoma, Norman, OK (US)

(72) Inventors: Hemang Subramanian, Miami, FL (US); Ziyang Zhang, Miami, FL (US); Florent Rouxelin, Miami, FL (US); Patricia Angle, Norman, OK (US)

(21) Appl. No.: 19/195,167

(22) Filed: Apr. 30, 2025

(51) Int. Cl. G06Q 40/04; G06Q 30/0202

(52) U.S. Cl. CPC G06Q 40/04; G06Q 30/0202; G06Q 2220/00

(57) ABSTRACT

Systems and methods for decision support for trading cryptocurrency are provided that combine fine-grained signals derived from news and social media with cryptocurrency (e.g., Bitcoin (BTC)) prices using a long short-term memory (LSTM) neural network. A portfolio can be constructed to trade cryptocurrency (e.g., BTC) in three stages. In the first stage, signals and prices can be used as inputs for the LSTM model to predict cryptocurrency (e.g., BTC) prices. In the second stage, the signals that are the most effective predictors of cryptocurrency (e.g., BTC) prices can be identified and then combined to generate predictions that outperform market benchmarks. In the third stage, portfolios can be assessed based on their financial performance relative to the market benchmarks.

### BACKGROUND

Cryptocurrency assets, a relatively recent development, hold significance due to their dual function in that they can act both as alternatives to traditional fiat currencies and as tokenized securities, complementing stocks or commodities. These assets arose from the advent of blockchain technology and are traded on centralized platforms like Coinbase. Cryptocurrencies are also traded on decentralized exchanges; among others, the decentralized exchange featuring the highest trading volume is Uniswap protocol. Cryptocurrency assets are exchanged continuously around the clock on global platforms for either fiat currencies, such as the US dollar, or other digital assets.

As the number of cryptocurrency investors grows, reinforced by recent participation from institutional investors, the unexploited opportunities for trading diminish. While the efficient market hypothesis contends that asset prices should incorporate all available information in markets, proponents of Limits of Arbitrage Theory argue that this information might still allow prices to deviate from their fundamentals, leading to persistent trading opportunities in markets.

For example, market frictions and investor constraints can delay price adjustments. In cryptocurrency markets, factors such as liquidity constraints, speculative behavior, and information delays may cause temporary deviations from fundamental value, creating short-term trading opportunities before prices adjust.

### BRIEF SUMMARY

Embodiments of the subject invention provide novel and advantageous systems and methods for decision support for trading cryptocurrency that combine fine-grained signals derived from news and social media with cryptocurrency (e.g., Bitcoin (BTC)) prices using a long short-term memory (LSTM) neural network. Unlike related art technical indicators, this approach dynamically adapts to market sentiment and external events, improving predictive accuracy. Through this artifact, a portfolio can be constructed to trade cryptocurrency (e.g., BTC) in three stages. In the first stage, signals and prices can be used as inputs for the LSTM model to predict cryptocurrency (e.g., BTC) prices. In the second stage, the signals that are the most effective predictors of cryptocurrency (e.g., BTC) prices can be identified and then combined in a unique way to generate predictions that outperform market benchmarks. In the third stage, portfolios can be assessed based on their financial performance relative to the market benchmarks. Embodiments can harness the inherent heterogeneity of online news and social media for cryptocurrency (e.g., BTC) price prediction, enabling a more adaptive trading framework compared to static algorithmic models.

In an embodiment, a system for decision support for trading cryptocurrency can comprise: a processor; and a (non-transitory) machine-readable medium in operable communication with the processor and having instructions stored thereon that, when executed by the processor, perform the following steps: i) receiving first time-series data comprising prices of a cryptocurrency (e.g., BTC); ii) receiving second time-series data comprising a plurality of index signals, each index signal of the plurality of index signals being derived from a market index based on at least one of a news source and a social media source; iii) integrating the first time-series data and the second time-series data to give an integrated dataset; iv) utilizing an LSTM neural network on the integrated dataset to give output comprising predicted prices of the cryptocurrency; v) generating a first portfolio based on the predicted prices of the cryptocurrency, the first portfolio comprising first market signals regarding the cryptocurrency; and vi) providing the first market signals to the LSTM neural network and repeating steps iv) and v) at least one time, with the LSTM neural network also utilizing the latest first market signals in each repeated step iv), to generate a final portfolio based on the latest predicted prices of the cryptocurrency, the final portfolio comprising final market signals regarding the cryptocurrency. In addition to executing the LSTM model, the processor can also continuously refine input signals through a feedback loop, dynamically adjusting trading signals in response to evolving market conditions. The first market signals can comprise a plurality of combinations of first market signals, and the final market signals can comprise a subset of the plurality of combinations of first market signals (i.e., the final market signals can comprise the most performant or best performing (based on the LSTM neural network) combinations). Step vi) can include repeating steps iv) and v) until the LSTM neural network determines the most performant combinations of first market signals. The instructions when executed can further comprise: vii) providing investment recommendations to a user based on the first portfolio. That is, the system can use a feedback loop that takes into account a large number of combinations of signals to give the final plurality of market signals, thereby giving an advantage over the market with the final portfolio (which can be used to provide investment recommendations to a user in order to help that user beat the market). The plurality of combinations of first market signals can comprise, for example, 120 combinations of signals. The first market signals can comprise, for example, price forecast (PF), price momentum (PM), price direction (PD), code upgrade (C), future versus past (F), HODL (H), and violence (V) (though other signals can be included). The plurality of combinations of first market signals can comprise combinations (e.g., 120 combinations) of PF, PM, PD, C, F, H, and V. The plurality of index signals can comprise, for example, at least 30 index signals (e.g., 55 index signals, at least 55 index signals, or about 55 index signals). The LSTM neural network can comprise two LSTM layers and two dropout layers; this configuration of the LSTM neural network was arrived at through several months of testing alternative configurations and loss functions. The system can further comprise a display in operable communication with the processor and/or the machine-readable medium. The instructions when executed can further comprise: viii) displaying the first portfolio, the first market signals, the final portfolio, the final market signals, and/or the investment recommendations on the display.

In another embodiment, a method for decision support for trading cryptocurrency can comprise: i) receiving (e.g., by a processor) first time-series data comprising prices of a cryptocurrency (e.g., BTC); ii) receiving (e.g., by the processor) second time-series data comprising a plurality of index signals, each index signal of the plurality of index signals being derived from a market index based on at least one of a news source and a social media source; iii) integrating (e.g., by the processor) the first time-series data and the second time-series data to give an integrated dataset; iv) utilizing (e.g., by the processor) an LSTM neural network on the integrated dataset to give output comprising predicted prices of the cryptocurrency; v) generating (e.g., by the processor) a first portfolio based on the predicted prices of the cryptocurrency, the first portfolio comprising a first plurality of market signals regarding the cryptocurrency; and vi) providing the first market signals to the LSTM neural network and repeating steps iv) and v) at least one time, with the LSTM neural network also utilizing the latest first market signals in each repeated step iv), to generate a final portfolio based on the latest predicted prices of the cryptocurrency, the final portfolio comprising final market signals regarding the cryptocurrency. With respect to step iii), the method can incorporate a multi-stage filtering approach where signals are initially ranked based on historical correlation with asset price movements, pruned through a recursive feature elimination process, and dynamically weighted before being processed by the LSTM model. The first market signals can comprise a plurality of combinations of first market signals, and the final market signals can comprise a subset of the plurality of combinations of first market signals (i.e., the final market signals can comprise the most performant or best performing (based on the LSTM neural network) combinations). Step vi) can include repeating steps iv) and v) until the LSTM neural network determines the most performant combinations of first market signals. The method can further comprise: vii) providing (e.g., by the processor) investment recommendations to a user based on the first portfolio, and optionally, investing by the investor (e.g., in the cryptocurrency market) based on the investment recommendations. That is, the method can use a feedback loop that takes into account a large number of combinations of signals to give the final plurality of market signals, thereby giving an advantage over the market with the final portfolio (which can be used to provide investment recommendations to a user in order to help that user beat the market). The plurality of combinations of first market signals can comprise, for example, 120 combinations of signals. The method can further comprise: viii) displaying (e.g., on a display in operable communication with the processor) the first portfolio, the first market signals, the final portfolio, the final market signals, and/or the investment recommendations. The first market signals can comprise, for example, PF, PM, PD, C, F, H, and V (though other signals can be included). The plurality of combinations of first market signals can comprise combinations (e.g., 120 combinations) of PF, PM, PD, C, F, H, and V. The plurality of index signals can comprise, for example, at least 30 index signals (e.g., 55 index signals, at least 55 index signals, or about 55 index signals). The LSTM neural network can comprise two LSTM layers and two dropout layers.

In many embodiments, the first market signals can include specific components comprising, but not limited to, PF, PM, PD, C, F, H, and V, and these first market signals may be utilized individually or in various combinations (e.g., 120 combinations) of PF, PM, PD, C, F, H, and V, to give final market signals comprising the same components (i.e., PF, PM, PD, C, F, H, V) in conjunction with one another, and where the final market signals include the most performant combinations from the various combinations of first market signals.

### BRIEF DESCRIPTION OF DRAWINGS

FIG. 1 shows a flow diagram of operationalization of sensemaking, signaling, and information processing theories for market predictions, according to an embodiment of the subject invention.

FIG. 2 shows an architecture of a Long Short-Term Memory (LSTM) engine for bitcoin price prediction using MarketPsych signals, according to an embodiment of the subject invention. A loop can incorporate 120 signal combinations feeding back into the LSTM engine, refining from an initial filtering of seven positive return signals.

FIG. 3 shows architectures of variations of LSTM engine configurations, according to embodiments of the subject invention. The objective functions can remain agnostic to the number of layers.

FIG. 4a shows loss functions, represented by mean absolute error (MAE), for each of the three LSTM engine configurations outlined in FIG. 3. The 1-layer LSTM engine configuration had the smallest MAE; the 3-layer LSTM engine configuration had the second-smallest MAE; and the 4-layer LSTM engine configuration had the largest MAE.

FIG. 4b shows loss functions, represented by mean squared error (MSE), for each of the three LSTM engine configurations outlined in FIG. 3. The 1-layer LSTM engine configuration had the smallest MSE; the 3-layer LSTM engine configuration had the second-smallest MSE; and the 4-layer LSTM engine configuration had the largest MSE.

FIG. 4c shows loss functions, represented by mean absolute percentage error (MAPE), for each of the three LSTM engine configurations outlined in FIG. 3. The 1-layer LSTM engine configuration is represented by the curve with the largest spikes; the 3-layer LSTM engine configuration is represented by the curve with the second-largest spikes; and the 4-layer LSTM engine configuration is represented by the curve with the smallest spikes.

FIG. 4d shows loss functions, represented by MAE, across four distinct node configurations. The 25-node configuration had the largest MAE on average, while the 100-node configuration had the smallest MAE on average.

FIG. 5a shows a graph of cumulative returns for long-short bitcoin strategies based on the top seven individual signals. The curves from highest to lowest at the far-right-hand side of the plot are for priceforecast, pricemom, pricedirection, codeupgrade, futurevspast, hold, and violence, respectively.

FIG. 5b shows a graph of cumulative returns comparing the combo strategy with benchmarks. The curves from highest to lowest at the far-right-hand side of the plot are for combo, mkt, BHB, and ARMA, respectively.

FIG. 6a shows a graph of cumulative returns of the top six mixed signals long-short bitcoin strategies. The curves from highest to lowest at the far-right-hand side of the plot are for V_F_C_PM_PF, V_C_PF, V_H_C_PD_PM, H_F_C_PM, V_H_C_PM_PF, and V_H_C_PM, respectively. FIG. 6a illustrates only the top six signal combinations that achieved cumulative returns of at least 150% during the sample period. While the other eight combinations (from a total of 14) are not depicted due to potential visual congestion, their financial performances can be referenced in the table in FIG. 10.

FIG. 6b shows a graph of cumulative returns comparing the combo strategy with benchmarks. The curves from highest to lowest at the far-right-hand side of the plot are for combo, mkt, BHB, and ARMA, respectively.

FIG. 7a shows an depiction of news and social media text analysis, predominantly focusing on the explicit content of the textual message.

FIG. 7b shows a depiction of an enhanced approach (compared to FIG. 7a), according to an embodiment of the subject invention, incorporating a diverse set of signals that encompass both the explicit message content and potential reader interpretations. The most predictive signals influencing reader-investors' actions can be identified, and signal combinations can be leveraged to improve predictive accuracy.

FIG. 8 shows a table of descriptive statistics for bitcoin returns and individual signal strategies. BHB denotes the buy-and-hold bitcoin strategy; MKT refers to the equity market data sourced from the Kenneth French data library; and ARMA characterizes the ARMA(3,3) benchmark. Signals such as ‘violence’, ‘hodl’, ‘futurevspast’, ‘codeupgrade’, ‘pricedirection’, ‘pricemom’, and ‘priceforecast’ represent different market indicators, with each label capturing the essence of its respective signal. For instance, ‘hodl’ embodies the HODL market sentiment, which is a strategy of holding an investment rather than selling it (i.e., holding an investment for a long period of time (e.g., at least one year)). The ‘combo’ strategy is the equally weighted average return derived from these seven signals. The table in FIG. 8 offers a range of statistics including the total number of observations (N), mean, standard deviation (sd), minimum (min), median (p50), maximum (max), skewness (skew), kurtosis (kurt), maximum drawdown (mdd), Sharpe ratio (SR), and the cumulative return (cum ret) for each listed variable.

FIG. 9 shows a table of regression results for bitcoin's excess returns (BHB) in relation to select signal indices. These indices reflect diverse market signals: price forecast (PF), price momentum (PM), price direction (PD), code upgrade (C), future versus past (F), HODL (H), and violence (V), where HODL refers to the HODL strategy of holding an investment rather than selling it (i.e., holding an investment for a long period of time (e.g., at least one year)). The independent variables, derived from the Kenneth French data library, are: market excess returns (mktrf); size factor (smb or Small Minus Big); value factor (hml or High Minus Low); profitability factor (rmw or Robust Minus Weak); and investment factor (cma or Conservative Minus Aggressive). Coefficient estimates are provided, with standard errors in parentheses. Statistical significance is indicated as follows: “***” indicates p<0.01, “**” indicates p<0.05, and “*” indicates p<0.1.

FIG. 10 shows a table of grouped indices classified into five primary categories by MarketPsych Analytics indices-Emotional, Price, Factual, General, and Slang signal combinations. The combinations featured are mix55, (PD, PM, PF), (V, H), (V, PD), (V, H, C, PD, PM, PF), (V, H, PD, PM), (V, H, C), (H, C), (V, H, C, PM), (V, H, C, PD, PM), (V, H, C, PM, PF), (V, F, C, PF), and (H, F, C, PM). Each combination is analyzed using various statistical measures—N, mean, sd, min, p50, max, skew, kurt, mdd, SR, and cum ret (see also the description of FIG. 8 above for explanation of these abbreviations). The ‘combo’ variable is a unique blend of all indices, and its statistics are presented separately. The table in FIG. 10 aims to offer insights into the performance and characteristics of these varied index combinations. It is noted that “mix55” is a combination of signals that is derived and fed back into the LSTM engine with the highest returns, and arriving at the mix55 combination of signals is an innovation that used a two phase filtering system with a feedback loop for combinations. Mix55 is discussed in more detail below.

### DETAILED DESCRIPTION

Embodiments of the subject invention provide novel and advantageous systems and methods for decision support for trading cryptocurrency that combine fine-grained signals derived from news and social media with cryptocurrency (e.g., Bitcoin (BTC)) prices using a long short-term memory (LSTM) neural network. Through this artifact, a portfolio can be constructed to trade cryptocurrency (e.g., BTC) in three stages. In the first stage, signals and prices can be used as inputs for the LSTM model to predict cryptocurrency (e.g., BTC) prices. In the second stage, the signals that are the most effective predictors of cryptocurrency (e.g., BTC) prices can be identified and then combined in a unique way to generate predictions that outperform market benchmarks. In the third stage, portfolios can be assessed based on their financial performance relative to the market benchmarks. Embodiments can harness the inherent heterogeneity of online news and social media for cryptocurrency (e.g., BTC) price prediction.

Comments from message boards and other social media platforms serve as value signals, showing the influence of information on stock prices in equity markets. Similarly, aggregated signals, sourced from communications from subject matter experts like traders and analysts, demonstrate predictive power. However, related art systems and methods tend to simplify the pivotal connection between the content of a message and the subsequent decision to act on it. Many studies interpret the signal perceived by the reader as a direct catalyst for trading decisions. When sentiment of a message is analyzed in the related art, it typically employs ‘black box’ algorithms like Latent Sentiment Analysis or relies on dictionary-based (lexical) sentiment analysis methods. Such approaches postulate an immediate link between a message's text and the ensuing action. Consequently, they mainly categorize messages broadly into general categories, such as positive/negative, capturing only the explicit expression and often overlooking the potential reader interpretation. The Sensemaking Perspective (SP) of organizational theory posits that interpretation bridges observation and action. Most existing research methods lack the detailed and varied signals needed to understand how readers process signals before making decisions.

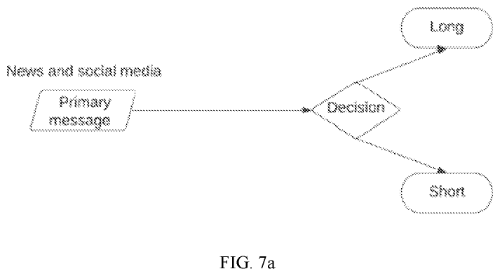

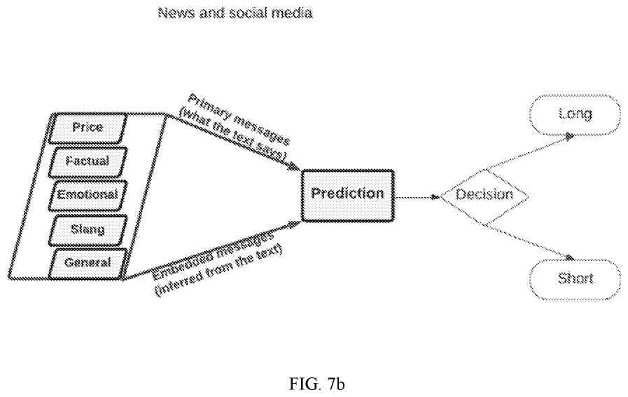

The relationship between signals and action is moderated by the trader's capacity to both identify and quantify those signals most likely to impact asset prices. While many related art systems primarily address sentiments from text data and their influence on asset prices, embodiments of the subject invention delve into a fine-grained interpretation of signals within such text. Sentiments represent just one form of information extracted from text; embodiments of the subject invention encompass both “face value” information and signals derived from the text. The relationship between the textual message and a trading decision is depicted in FIG. 7a, and a novel aspect of embodiments of the subject invention (i.e., identifying relevant signals and assessing the extent of their predicting power on the market) is depicted in FIG. 7b.

Deviations from fundamental value in asset prices arise from factors such as the bounded rationality of individual traders, capital restrictions, cognitive biases, and elements like information accessibility and opportunity. Proponents of the limits of arbitrage theory suggest that when arbitrageurs have access to superior “value” signals, they rapidly deploy capital to eliminate price inefficiencies. Yet, distinguishing noise from genuine, superior signals remains a complex task, given the type of information available and the methodologies for analyzing such data. Embodiments of the subject invention place a primary emphasis on cryptocurrency assets, notably BTC.

There are distinct operational differences between cryptocurrency and traditional equity markets. Notably, cryptocurrencies like BTC are decentralized, meaning they are not under the control of any single authority, eliminating any single-party bias. Additionally, discussions among traders and analysts frequently occur on platforms like Discord, Quora, Telegram, Facebook, and Twitter, often unhindered by stringent legal regulations. Further, media coverage of cryptocurrency offers valuable information from which to extract “value” signals. Leveraging deep learning techniques makes it feasible to obtain such signals from this data. Given the global nature of cryptocurrency markets, trading can occur non-stop, allowing for nearly instantaneous information use, signal generation, and application.

Embodiments of the subject invention can adopt a design science approach to construct an information technology (IT) artifact that combines signal data and financial data to predict BTC prices (see also; Gregor et al., Positioning and presenting design science research for maximum impact, MIS Q. 37 (2) (2013) 337-355; and Hevner et al., Design science in information systems research, MIS Q. 28 (1) (2004) 75-105; both of which are hereby incorporated by reference herein in their entireties). Algorithms can be developed and used to evaluate various portfolios and compare their performances.

Embodiments of the subject invention can address whether signals derived from social media possess predictive power and can be utilized to capitalize on trading opportunities. Achieving an information advantage to devise superior trading strategies is an emerging area of research in machine learning. Thus, the following questions are relevant to embodiments of the subject invention: (1) How can predictive power be derived from signals in news and social media? (2) Can signals be identified and combined to devise trading strategies that outperform market benchmarks? (3) Can the risk-adjusted performance of real-time strategies be assessed compared to standard market benchmarks?

Embodiments of the subject invention present a novel decision support system based on the predictive power of signals for cryptocurrency (e.g., BTC) prices. By integrating signals from diverse sources such as news and social media, the system can harness both long- and short-term memory mechanisms to increase the prediction accuracy. The system can be grounded in principles inspired by information processing theory and can have significant practical relevance. The system can use IT artifact designed to capture and utilize the vast heterogeneity of social media and news information through a plurality of signals (e.g., at least 30 signals, such as at least 55 signals, about 55 signals, or exactly 55 signals), rather than merely considering sentiments. These signals undergo a structured two-stage filtering process, facilitating more comprehensive and nuanced BTC return predictions. Precise performance evaluation metrics can be established, complemented with benchmarks. These benchmarks serve not only as academic tools but also as practical guides, highlighting signal combinations that deliver superior risk-adjusted returns and offering investors a ready-to-implement strategy in real time.

Embodiments of the subject invention can build on the foundational concepts of sensemaking theory, signaling theory, and information processing theory (IPT) to inform the design of the IT artifact. Additionally, insights from prediction markets can be leveraged and used as a tool to utilize the collective wisdom of the crowd, thereby refining the financial predictions using tailored neural networks.

Sensemaking is traditionally conceptualized as the iterative process of creating frameworks or narratives to stabilize the streaming of experience by focusing on a limited set of cues and elaborating them into a plausible guide for action (see also Sutcliffe, Sensemaking, in: M. Augier, D. J. Teece (Eds.), The Palgrave Encyclopedia of Strategic Management, Palgrave Macmillan UK, London, 2018, pp. 1544-1547; which is hereby incorporated by reference herein in its entirety). This process involves the active processing of information to achieve understanding, moving beyond mere data acquisition to involve deeper comprehension and the tackling of ill-structured problems. Given the persistent fluctuations in prices and the consistent flow of information from news and social media, it becomes essential to identify and process cues from this continuous data. The sensemaking perspective underscores the possibility of extracting cues from continuous data streams. Once these cues are discerned and processed, they can serve as distinct signals, enabling the differentiation of valuable insights from noise or the identification of unique combinations with high predictive power.

Signaling theory focuses on the dynamics of communication when two parties engage in transactions under asymmetric information. In such scenarios, both parties rely on signals to bridge informational gaps. In cryptocurrency markets, signals predicting future value come from a variety of sources. Investors often analyze the historical performance values of other cryptocurrencies, monitor news updates, and study discussions on message boards. Signals can be classified as intentional and positive forms of communication. Within this framework, the message receiver, typically an informed insider, is attentive to signals from sources such as press releases, market news, and company prospectus disclosures. Correlations have been found between rumors on message boards, abnormal returns, and trading volume. There remains a limited understanding of the effects of implicit, or embedded, messages. Such signaling occurs through nuances and emotions inferred from a message, conveying more information than what is explicitly stated. The detection and classification of these embedded signals can be challenging. In cryptocurrency markets, the presence of embedded signals is pronounced, partly because some investors might not fully grasp the intricacies of underlying blockchain technology. Consequently, they might invest based on anticipated rapid gains, despite the notable volatility inherent to cryptocurrencies. Embodiments of the subject invention can incorporate signals from news and social media and combine them with trading data to predict future cryptocurrency (e.g., BTC) prices.

Research on sentiment analysis has investigated the influence of text messages from social media, news, and message boards on entities such as users, companies, valuations, and consumers. Sentiment captures a range of both objective and subjective indicators reflecting human emotions. While early sentiment analysis predominantly focused on discerning the polarity of a message, advancements in machine learning have facilitated the detection of nuanced emotions, such as sarcasm. Researchers have employed diverse methodologies to underscore the impact of sources like social media, Google Trends, Twitter sentiment, and news on asset price movements. Embodiments of the subject invention emphasize the rich diversity of embedded signals originating from social media and news. The decision support system can detect signals and capitalize on them to predict cryptocurrency (e.g., BTC) price and outperform market benchmarks.

IPT articulates how humans efficiently utilize information to address challenges, considering cognitive constraints. It encompasses mechanisms such as machine-based intelligence and the interplay between short-term and long-term memory, highlighting strategies to mitigate the decay of short-term memory. Over the past decades, IPT has influenced fields like control theory, organizational design, and marketing. In these areas, it has been explored how information processing facilitates the development of individual processes. IPT has been utilized to enhance organizational design and streamline system controls by effectively processing information and adhering to predefined processes. Investors in the BTC market face two primary challenges that IPT can help address. First, assigning relative importance to both old and new information poses a dilemma regarding which information to retain and which to disregard. Second, human cognitive capacity is often exceeded by the number of categories into which new information can be classified, especially when immediate decision-making is required.

Given these complexities, the principles of IPT can be utilized in embodiments of the subject invention. In particular, the application of IPT is twofold; first, signals derived from information available from social media can be used, represented by a plurality of signals (e.g., 55 signals) across a plurality of categories (e.g., five categories), which then serve as inputs to the system. Subsequently, the system can process these signals, utilizing the short-term data while ensuring that useful signals transition into long-term memory for downstream processing. In subsequent stages, cryptocurrency (e.g., BTC) prices can be forecasted based on individual signals and their combinations. After evaluating the performance of these predictions, non-contributory signals can be eliminated. The system can be refined by iterating through these steps, optimizing for the most effective trading strategies.

Online communities play pivotal roles in both value creation and value assessment. Interestingly, user generated content can have a more significant influence on a product's perceived value than messages from official sources, such as the product's originating company. Product information found on social media can be perceived as more valuable than that on the product's official website. Customer value can be defined by criteria such as quality, delivery, and cost. Similar to how service time affects perceived value in discretionary services, the timing and source of information might influence how cryptocurrency (e.g., BTC) investors value data. The breadth and frequency of topics in a dataset, including “criminal activity,” “fear of missing out (FOMO),” and “innovation,” suggest that BTC investors value information similarly to other customers. If online discussions reflect BTC's value, these diverse signals can possess predictive power. Embodiments of the subject invention can remain agnostic regarding the proportion of traders to writers, though it is likely the case that a large portion of those writing about news and social media topics are also active traders.

The development of neural networks has led to numerous variants, primarily distinguished by their methods of updating weights for individual nodes. Recurrent neural networks (RNNs) extend the capabilities of convolutional neural nets by incorporating the activation functions from previous inputs, enabling them to process sequential or time-dependent data more efficiently. For instance, given the tendency of the letter “q” in English to be succeeded by “u,” an RNN-based spell-checking algorithm can use such patterns to identify likely errors in sequence.

A notable RNN variation is the LSTM. It efficiently tackles the vanishing gradient problem, where error values may diminish during back-propagation, causing nodes distant from the output to stop learning (see also; Hochreiter, The vanishing gradient problem during learning recurrent neural nets and problem solutions, Int. J. Uncertain. Fuzziness Knowl. Based Syst. 6 (02) (1998) 107-116; and Hochreiter et al., Long short-term memory, Neural Comput. 9 (8) (1997) 1735-1780; both of which are hereby incorporated by reference herein in their entireties). The LSTM design ensures a consistent error backpropagation, allowing earlier nodes to continually affect the output layer. Such capabilities make LSTM a favored choice for predicting cryptocurrency prices, specifically when handling price-related temporal data. The LSTM-ReGAT model combines LSTM with a graph attention network (ReGAT) for cryptocurrency price trend prediction (see also Zhong et al., LSTM-ReGAT: a networkcentric approach for cryptocurrency price trend prediction, Decis. Support. Syst. 169 (2023), 113955; which is hereby incorporated by reference herein in its entirety). This model considers both individual features and interrelations among cryptocurrencies, recognizing that one's price movement can affect others. The integration of LSTM and ReGAT offers a robust tool for predicting price trends in the dynamic cryptocurrency market.

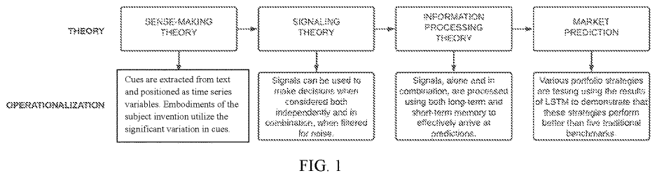

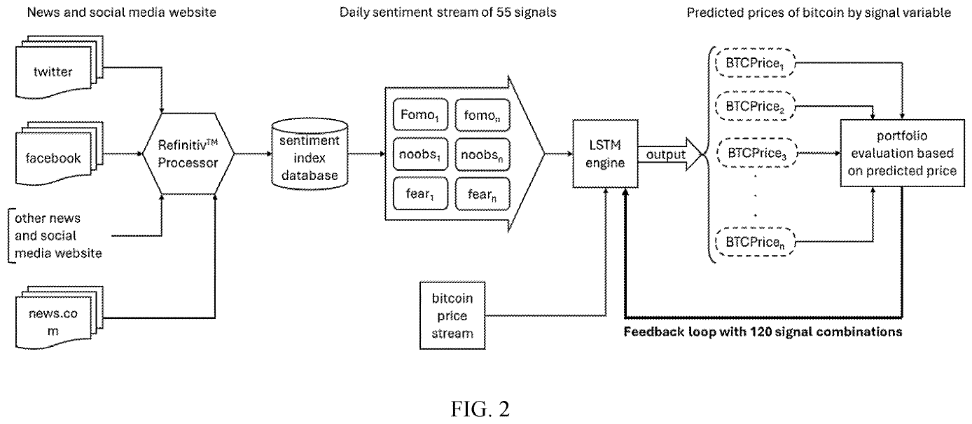

Embodiments of the subject invention can integrate pattern analysis with LSTM, illustrating how effective variable selection improves price prediction accuracy. This detailed exploration paves the way for the enhanced prediction of cryptocurrency prices by combining quantitative signal predictors. Embodiments also integrate and apply the principles from sensemaking theory, signaling theory, information processing theory, and market predictions, as depicted in FIG. 1. This integration sheds light on the significance of these theories in shaping the distinctive artifact design and the ensuing evaluation of the generated predictions (see also FIG. 2).

Embodiments of the subject invention include a decision-support artifact that can cater to the broader scope of cryptocurrencies while also ensuring precise market prediction. Embodiments can achieve at least the following four objectives: objective 1—obtain signals and market movements to discern a relationship; objective 2—exploit the heterogeneity in signals obtained from news and social media sources; objective 3—capture dual memory dynamics of heterogeneous signals for prediction; and objective 4—output with actionable insights.

With respect to objective 1, the foundational basis is that sentiments and other information derived from news and social media improve price predictions in cryptocurrency markets. Additionally, sensemaking theory and signaling theory require a predictive system to be based on data that is current and data that captures the heterogeneity of signals derivable from readily available information. Based on an emphasis in predictive value of information signals and the foundational belief that the market reflects the collective wisdom of all investors, the artifact of embodiments of the subject invention can adeptly discern the correlation between informational signals and market movements. By integrating time-series financial metrics from Yahoo! Finance on BTC prices and time-series data on 55 distinct signals derived from information, the artifact can be designed to uncover and analyze the relationship between informational signals and market fluctuations.

With respect to objective 2, the foundational basis is that signaling theory and the informative value of social media highlights the need for extracting “implied” and “direct” signals. Particularly in the presence of uncertainty, IPT informs how information can be linked to effective decision-making. The inclusion of heterogeneous independent signals combined with price information can improve predictability. The objective here is to illustrate the use of cryptocurrency discussions across various media platforms like Discord, Quora, Telegram, Facebook, and Twitter. MarketPsych indices are computed using information derived from these news and social media sources (see also, marketpsych.com). The artifact of embodiments of the subject invention can tap into 55 signals, derived from streaming data collected by MarketPsych Analytics' engine.

With respect to objective 3, the foundational basis is that IPT highlights the need to be able to effectively capture short-term information signals while utilizing long-term trends to facilitate prediction. Recognizing that the cryptocurrency market, especially BTC, is influenced by both real-time signals (short-term memory) and historical patterns (long-term memory), the objective can be to capture both these dynamics. This dual memory dynamic enables a filtering of noise from value signals, while simultaneously enabling the combination of value signals to improve the prediction. The artifact of embodiments of the subject invention can utilize LSTM neural networks to analyze both real-time signals and historical patterns through filtering based on predictions derived from separate signals and combinations of performant signals. The noise can be filtered from “value” signals and signal combinations.

With respect to objective 4, the foundational basis is that the aim is to outperform market performance by comparing the portfolio predictions against market performance benchmarks using several established risk-adjusted metrics. With a practical focus, the artifact's output can go beyond mere analysis and predictions, and comparisons with multiple performance benchmarks and market metrics can be enabled for practical use. The artifact of embodiments of the subject invention can be designed to provide investors with clear, actionable insights, underlining the risk dimensions of each strategy, with the overarching aim of consistent market outperformance. Objectives 1-4 can help ensure a balance between theoretical depth and actionable insights in the field of cryptocurrency investments.

The artifact of embodiments of the subject invention can incorporate time-series data on BTC prices, along with 55 distinct signals. BTC is recognized as the first decentralized blockchain, and its longevity has provided an extensive dataset in comparison to many of its successors (see also Rauchs et al., Global Cryptocurrency Benchmarking Study, Cambridge Centre for Alternative Finance Reports, 2017; which is hereby incorporated by reference herein in its entirety). Key metrics, including daily open, close, highest, and lowest prices, as well as the daily trading volume, are crucial for understanding market movements. These metrics can be sourced from, for example, Yahoo! Finance, which in turn obtains its BTC price information from CoinMarketCap. By integrating these metrics with 55 disparate signals derived from the MarketPsych indices, the relationship between informational signals and market fluctuations can be discerned. This approach provides a reliable dataset to contrast against the MarketPsych signals, effectively addressing objective 1. This data spans from Oct. 17, 2014, to May 18, 2023.

In alignment with objective 2, the IT artifact's design emphasizes the heterogenous nature of signals that measure the cues obtained from information. The utilization of signals from readily accessible public sources, encompassing both social media and news websites, is critical for the artifact's practical applicability. The MarketPsych Analytics indices can be used to train the artifact, leveraging the capabilities of a real-time aggregator that accumulates crypto-specific signals from a wide array of over 4000 news and social media sources.

In the context of objective 3, which aims to capture the dual memory dynamics of heterogeneous signals for prediction, the method employed for collecting and refining signals is of significance. Initially, dictionaries play an active role in pinpointing and scoring signals present within the text. These dictionaries are adept at recognizing text patterns, especially those that employ wildcards, which are occasionally utilized to navigate around social media restrictions. Further, these dictionaries are tailored to identify finance-centric signals, drawing upon both academic insights and industry professional input. Signals representing unipolar emotions like “joy” oscillate between 0 and 1, while bipolar signals, exemplified by “loveHate”, fluctuate from −1 to 1. Within this framework, negative values typically denote less favorable sentiments. Finally, the data from news and media sources can be compiled into a single daily index for every variable.

Subsequently, these scores can undergo adjustments, considering factors like emphasis, negation, and other contextual clues. If there is no detected signal for a particular day, that observation remains empty. For such gaps, the missing values can be filled in with the previous day's data, ensuring that the neural network can process the signal continuously. This approach presumes that in the absence of new information, the signal remains consistent without inducing a lookahead bias in the results. Such an approach is essential to guarantee the real-time functioning of the strategy in tune with capturing dual memory dynamics without loss of information.

Addressing objective 4, the artifact can be not just limited to analysis and predictions using the LSTM neural network and associated predictions. The analysis transforms this data into actionable insights, through predictive analytics thus focusing on investor utility, while comparing performance using various market data combined with benchmark metrics.

Objective 3 was to capture dual memory dynamics-real-time signals and historical patterns of signals combined with price information. This is rooted in IPT, which posits that humans generally undergo three stages when forming memories. First, sensory inputs are either attended or discarded. Second, inputs that are attended to are held in short-term memory, where they may be rehearsed or forgotten. Third, information that is rehearsed transitions into long-term memory. A challenge with many neural network configurations is the decay of memory over time. An LSTM model maintains relevant information over time, while it employs a forget gate to discard irrelevant data, be it short-term or long-term. Embodiments of the subject invention can include a neural network that can be understood through three layers of abstraction: inputs and outputs; signal indices; and gates.

With respect to inputs and outputs, in line with objective 1 to discern the relationship between signals and market movements, the system can process a two-dimensional panel of inputs, which comprises both signals and financial data, denoted as X. Formally, it can be represented as:

$$X = [ \begin{matrix}{x}_{11} & … & {x}_{1 T} \\ ⋮ & ⋱ & ⋮ \\ {x}_{N 1} & … & {x}_{NT}\end{matrix} ] , \qquad ( 1 )$$

where N (where N≥1) is the number of input variables, capturing objective 2 by considering comprehensive inputs from various sources including both signals and financial data. T represents the total days in the observation period, and in this context, T=2958. The inputs can be the predicted cryptocurrency (e.g., BTC) close prices for all previous days in the observation period, y₁, y₂, . . . , yₜ₋₁, as well as the actual cryptocurrency (e.g., BTC) close prices for all previous days, shown as x₁₁, x₁₂, . . . , x₁₍ₜ₋₁₎, and the signal indices of the previous days, denoted as xₙ₁, xₙ₂, . . . , xₙₜ₋₁, which collectively reflect real-time sentiments and historical patterns in line with objective 3. The output, mapping to objective 4, is designed to be more than just raw data, providing a predicted current day closing price of cryptocurrency (e.g., BTC). With a target output series wherein yₜ∈R+, as well as the past and current values of driving series (X), the deep learning model endeavors to establish a mapping to the present value of the target series:

y_{T}:y^{T}=F(y₁,y₂, . . . ,yₜ₋₁,x₁₁,x₁₂, . . . ,x_{N(T-1)}) (2)

In equation (2), F(⋅) is a nonlinear mapping function, y_{T} is the predicted close price, and xₙₜ denotes the input price or signal at time t.

With respect to social media signals, in order to address objective 2 of utilizing heterogeneous signals, the analysis can use a plurality of distinct signals (e.g., 55 distinct signals) that are generated by MarketPsych Analytics' engine from over 4000 news and social media sources daily. Approximately 20% of the sources for BTC are news, with the remainder coming from social media. These signals can be classified into a plurality of categories (e.g., five categories) by MarketPsych Analytics (e.g., emotional, price, factual, slang, and general). While news or social media articles aim to provide factual (unbiased) information, readers can still experience an emotional response. Emotional variables are typically based on opinions and reflect the author's sentiment at the time of writing. Factual signals convey a primary message but often do not convey embedded information to the reader (e.g., criminal activity). Price variables convey beliefs or insights about the cryptocurrency's value. Their distinctiveness arises when there is mention of forecasted purchases, differing from references to buying in a broader context. Slang signals encompass terms with specific meanings acquired via social media usage, such as HODL (hold on for dear life), noobs (new traders), and FOMO (fear of missing out). General variables track mentions of BTC, timeframes, or the balance between emotion and fact. There are two types of signals-unipolar and bipolar. Signal polarity means that positive values align with positive sentiments, whereas negative values align with sentiments generally perceived as negative. Among other signals, criminal activity, optimism, and buzz are unipolar, while developer signal, long short, and long/short forecast are bipolar. For all variables, excluding buzz, each occurrence can be influenced by modifier words or negator words. For example, the word “very” in the statement, “bitcoin investors are very optimistic” would increase the count for “optimistic”. Conversely, “bitcoin investors are not optimistic” would decrease the count for “optimistic”. Given that variable counts can vary substantially, comparing their relationships with outcomes can pose econometric challenges. In order to address this, the activity signal named “buzz” can be utilized to normalize the other signals. Buzz represents the sum of the absolute values of the (modified) signal counts. Consequently, each unipolar signal typically ranges between [0,1], while each bipolar signal can span [−1,1].

With respect to gates, the architecture of LSTM is fundamentally aligned with objective 3, which seeks to capture dual memory dynamics prevalent in the cryptocurrency market. In particular, the gates of LSTM play a pivotal role in determining how the network manages and retains information across both short- and long-time intervals. This capability is crucial for understanding real-time sentiments and historical patterns in the market. LSTM incorporates gates alongside a mechanism termed cyclic redundancy carousels (more generally referred to here as cells) to maintain a nearly constant error flow throughout the system. This constant error flow is core to LSTM's design, addressing the challenges posed by the exploding and vanishing gradient problems. If an error within a cell becomes too large, the weights on the cell oscillate between large values, preventing or inhibiting the model from reaching convergence. Conversely, when the error in a cell is too small, learning (or updating) does not occur. Each gate operates based on inputs, xₙₜ, and the previous hidden state of the cell, hₜ₋₁. They include both a linear and a nonlinear feature. The linear feature takes the form of the equation y=Wx+b, where W denotes the weight, and b represents a bias. The network sets both the weight and bias in every epoch (iteration). The nonlinear function adopts a sigmoid form for each gate and uses the hyperbolic tangent for defining the cell state. Gates are classified into three categories-input, output, and forget. Activation of each gate is contingent upon the comparison of its function with each of the cell's state, represented as s(⋅). The cell state can be understood as a time-accumulated value of the cell, whereas the hidden state represents the cell's status during a specific epoch. The input gate assesses the information to be used as input into a cell, the output gate determines the information output from a cell, and the forget gate decides on the information to be discarded. Mathematically, the three gates, alongside the cell and hidden states, can be expressed as follows:

fₜ==σ(W_{f}[hₜ₋₁,x_{T}]+b_{f}) (3)

iₜ=σ(Wᵢ[hₜ₋₁,xₜ]+bᵢ) (4)

σₜ=σ(Wₒ[hₜ₋₁,x_{T}]+bₒ) (5)

sₜ=fₜ⊙sₜ₋₁+iₜ⊙ tan h(Wₛ[hₜ₋₁,xₜ]+bₛ) (6)

hₜ=oₜ tan h(sₜ) (7)

where σ indicates the sigmoid function and ⊙ denotes the Hadamard product.

The LSTM, consistent with objective 3's aim to capture dual memory dynamics, is a type of RNN that processes input sequences derived from feature representations, specifically the normalized input signals and close prices [25,26]. Given the input sequence X=(x₁, x₂, . . . , xₜ) where x₁ . . . xₜ∈R+ and t represents the day of observed inputs, the encoder's role is to discern a mapping from xₜ to hₜ=ƒ(hₜ₋₁, xₜ). In this relationship, hₜ∈Rₘ represents the hidden state of the encoder at time t. Additionally, m denotes the size of the hidden state, and ƒ is a non-linear activation function, often adopting a sigmoid form. Each LSTM unit comprises a memory cell characterized by the state sₜ at time t. Three sigmoid gates—the forget gate fₜ, input gate iₜ, and output gate oₜ—regulate access to this memory cell.

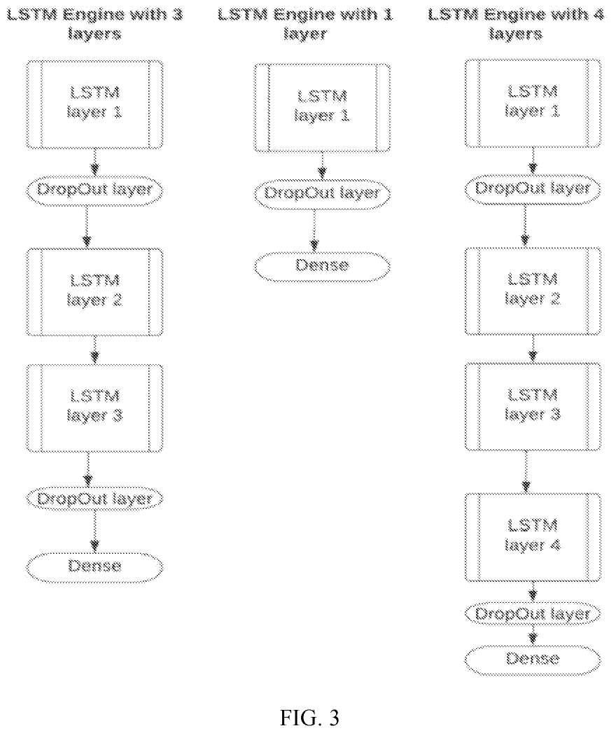

FIG. 3 shows architectures of variations of LSTM engine configurations, according to embodiments of the subject invention. On the left, the collation process can aggregate textual content from various news and social media sources, aligning with objective 2's focus on comprehensive inputs from news and social media sources. This aggregation can be performed by MarketPsych. This data can undergo analysis, populating the signal index database at daily and hourly intervals. This process can yield a data stream of 55 signals, a crucial step towards objective 1, discerning the relationship between signals and market movements. Two types of inputs can be fed: the cryptocurrency (e.g., BTC) price and signal indicator variables. The LSTM neural network engine can output a predicted cryptocurrency (e.g., BTC) price based on the provided input. Three configurations of the LSTM neural network engine can be used, as depicted in FIG. 3. Subsequently, signals (e.g., seven signals) can be identified that yield positive cumulative returns over the considered period. Combining these selected signals leads to 120 unique signal combinations. The LSTM can be employed on these combinations aiming to maximize risk-adjusted returns. Several combinations outperform individual signals in predictive accuracy and in generating higher risk-adjusted returns. The evaluation approach and financial performance analysis are discussed in the examples.

Embodiments of the subject invention can use signal filtering via LSTM loss functions and the identification of relevant signals associated with cryptocurrency price dynamics, exhibiting consistency and reliability in predicting cryptocurrency prices. The use of LSTM variable filtering serves as an instrumental mechanism to differentiate between noise and informative signals, thus addressing challenges often encountered with some neural network models. Contextually, the approach presents a practical implementation of IPT, integrating both long-term and short-term memory functions, and addressing the vanishing gradient problem commonly associated with many neural network models.

Under the direction of objective 4, emphasizing its real-world applicability, embodiments of the subject invention offer substantial value to practitioners, especially those within the investment sector. The results, which consistently outperform established benchmarks, underscore the potential of the signal-driven strategies in the dynamic world of cryptocurrency investments. Although BTC has been discussed at length herein, embodiments of the subject invention are applicable to any cryptocurrency.

Practitioners stand to gain significant insights from embodiments of the subject invention. The integration of carefully selected signals within the LSTM framework has been shown to yield superior risk-adjusted returns (see the Examples). This knowledge stands as a critical tool for traders aiming to optimize their market strategies. Further, the artifact is not static; it showcases a potential adaptability to encompass a wider range of quantitative signals, and even text-based indicators, thereby amplifying its predictive power. While the Sharpe ratio and other presented performance metrics are well-established measures in traditional finance, the cryptocurrency landscape, with its unique intricacies, demands a tailored approach. Embodiments of the subject invention have adopted the consistent use of risk-adjusted metrics to effectively evaluate cryptocurrency assets, ensuring that practitioners can achieve meaningful performance assessments regardless of the specific prediction models they employ.

Embodiments of the subject invention provide a focused technical solution to the focused technical problem of how to efficiently invest in cryptocurrency, as well as how to address the vanishing gradient problem commonly associated with neural networks. The solution is provided by utilizing a system/method addressing at least three of objectives 1-4 presented herein. Embodiments of the subject invention can improve the computer system providing decision support for trading cryptocurrency by addressing the vanishing gradient problem and providing efficient investment advice (these can free up memory and/or processor usage).

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When the term module is used herein, it can refer to software and/or one or more algorithms to perform the function of the module; alternatively, the term module can refer to a physical device configured to perform the function of the module (e.g., by having software and/or one or more algorithms stored thereon).

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Materials and Methods

The LSTM engine was assessed under various configurations, detailed in FIG. 3. The foundational LSTM layer used a batch size of 32 values from the time series, coupled with 100 nodes, and employed the Adam optimizer. A data split ratio of 85:15 was adopted for training to testing. In a specific configuration, 20% of the sample was randomly excluded, with the remaining data channeled through two successive LSTM layers, termed as layer 2 and layer 3. The resulting output from the dense layer yielded the projected BTC prices. The primary objective function was the mean absolute error (MAE), with the mean squared error (MSE) and mean absolute percentage error (MAPE) serving as a supplementary measure for robustness.

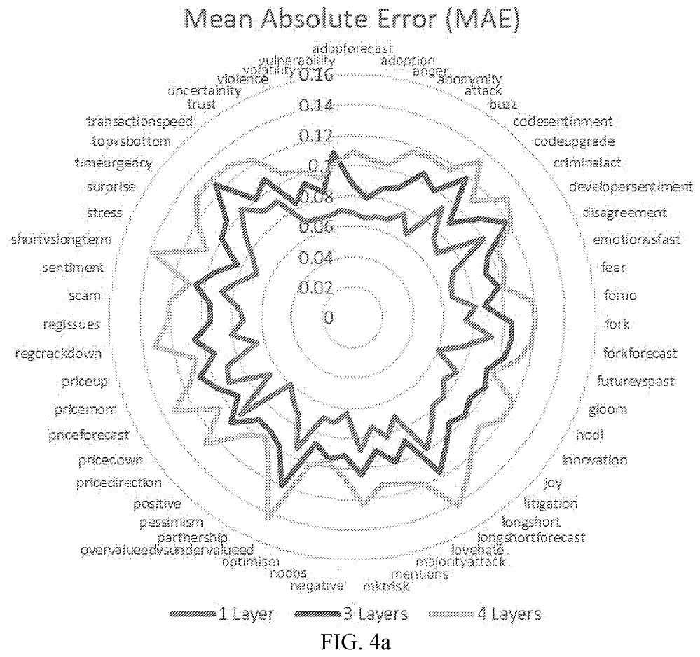

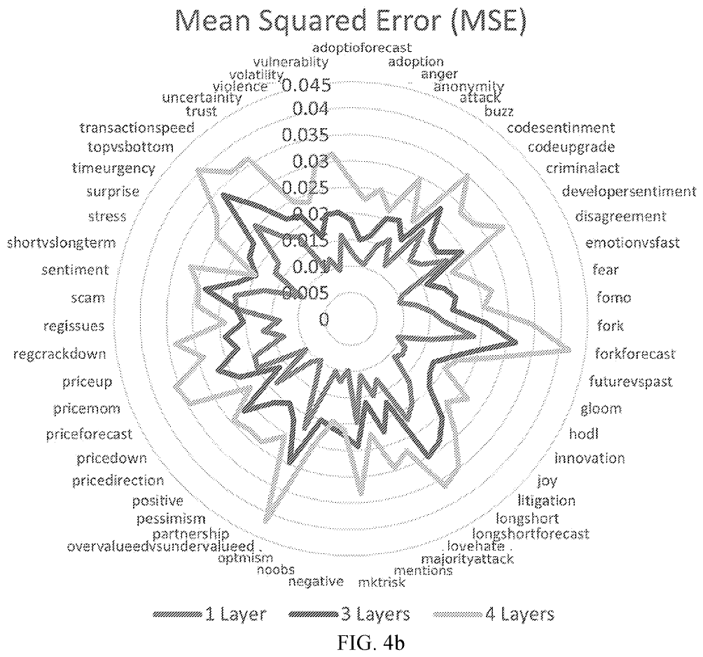

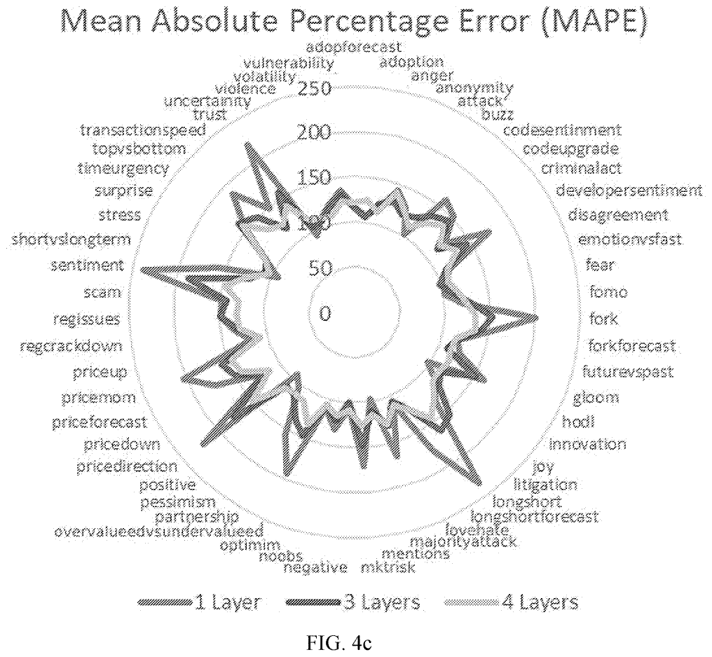

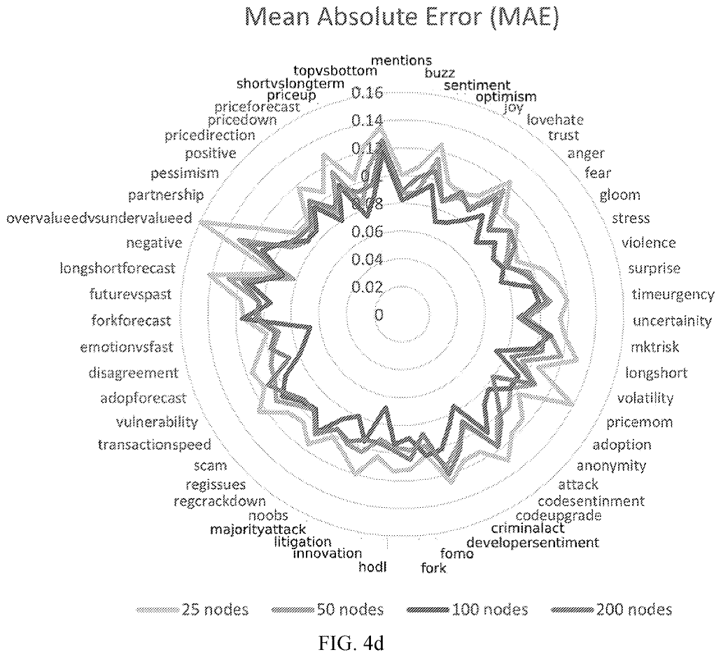

FIGS. 4a-4d provide a comprehensive analysis of the loss across different layer configurations. Specifically, FIGS. 4a, 4b, and 4c exhibit the loss for the LSTM configurations of 1, 3, and 4 layers using metrics MAE, MSE, and MAPE, respectively. Across these configurations, the observed differences in loss were minimal. The 3-layer configuration presented a consistent performance, prompting selection of it. FIG. 4d displays the loss measured by MAE across four node configurations, namely 25, 50, 100, and 200 nodes. The 100-node setup exhibited a lower loss, leading to selection of 100 nodes for the examples.

In order to address objective 1, signal indices were utilized to generate BTC price predictions and determine cumulative returns over the period of the test data until the last day of data collection. For each day, denoted as t, the most recent signal index value is fed into the LSTM engine. This produces an expected BTC price prediction for the subsequent day, Eₜ (P_{BTC,t+1}). This prediction was then used to guide trading decisions, as outlined:

$$\{ \begin{matrix}If {E}_{1} ( {P}_{BTC , t + 1} ) > {P}_{BTC , t} then BUY Bitcoin at price {P}_{BTC , t} and hold the position for 1 day \\ If {E}_{1} ( {P}_{BTC , t + 1} ) > {P}_{BTC , t} then BUY Bitcoin at price {P}_{BTC , t} and hold the position for 1 day\end{matrix} \qquad ( 8 )$$

With a focus on providing actionable insights, as described in objective 4, it is noted that short selling BTC is consistently feasible. Notably, platforms such as Kraken, Bitfinex, eToro, and Binance allow users to borrow, short-sell, and repurchase BTC later. This implies that short selling, and the strategy overall, is accessible not just to investment management firms, often well-positioned to capture risk-adjusted abnormal returns, but also to retail investors, addressing objective 4. Using these trading rules, cumulative returns associated with signal strategies were determined up to the sample's final day, T. The κ-day bitcoin cumulative return is the product of κ one-day returns:

$$\begin{matrix}1 + {CumRet}_{BTC , T} ( k ) = ( 1 + {( - 1 )}^{{BS}_{T … 1}} * {R}_{BTC} ( T ) ) * ( 1 \\ + {( - 1 )}^{{BS}_{T … 2}} * {R}_{BTC} ( T ) ) * … ( 1 \\ + {( - 1 )}^{{BS}_{T ¨ k}} * {R}_{BTC} ( T - k + 1 ) ) = {\prod }_{j = 0}^{k - 1} ( 1 \\ + {( - 1 )}^{{BS}_{T … j … 1}} * {R}_{BTC} ( T - j ) )\end{matrix} \qquad ( 9 )$$

for any {n∈ [symbol] +; k≤n≤T}:

$$\{ \begin{matrix}{BS}_{n} = 1 if a SELL order was triggered at time n \\ {BS}_{n} = 2 if a BUY order was triggered at time n\end{matrix} \qquad ( 10 )$$

$${R}_{BTC} ( n ) = \frac{{P}_{BTC} ( n ) - {P}_{BTC} ( n - 1 )}{{P}_{BTC} ( n - 1 )} \qquad ( 11 )$$

In order to ensure robust analysis, which is integral to objective 1, the cumulative weekly returns derived from daily returns were computed and examined, considering the distinct trading characteristics of BTC (continuous trading) versus equities (five-day trading weeks). This methodology offers an in-depth assessment of the strategies in relation to the equity market, one of the benchmarks. Evaluating weekly returns simplifies the comparison process and mitigates the effects of daily return noise, arising from market microstructure effects. Focusing on weekly returns provides a clearer understanding of the underlying performance trends and patterns of the strategies under consideration.

The performance of the signal-based trading strategies was evaluated using several portfolio performance metrics. The Sharpe ratio quantifies risk-adjusted returns, representing excess return per unit of risk and assuming of normal distribution. It is, however, sensitive to outliers. Cumulative returns capture the total return over a specific period. Despite their ease of interpretation and comparability, cumulative returns do not account for risk, the timing of returns, or provide a comprehensive timeframe analysis. Skewness returns gauge asymmetry in return distribution, indicating deviation from normality, but they are sensitive to outliers and do not encompass the entirety of distribution characteristics. Kurtosis evaluates the tail behavior of returns and identifies extreme observations. Yet, it also does not fully characterize the nature of tails. Maximum drawdown calculates the greatest loss from a peak to a trough, highlighting downside risk and loss potential. However, it does not quantify the frequency of drawdowns and is period sensitive. Each metric plays a crucial role in the assessment of the performance and risk attributes associated with different trading strategies. This approach aligns with the ability to study relationships between signals and market movements, as outlined in objective 1, while also delivering actionable insights in line with objective 4.

### Example 1

Seven signals with the highest Sharpe ratio were selected to construct the trading strategies (see also Sharpe, Mutual fund performance, J. Bus. 39 (1) (1966) 119-138; which is hereby incorporated by reference herein in its entirety). The Sharpe ratio of strategy i is defined herein as SRᵢ=(Rᵢ−r_{f})/σᵢ, where Rᵢ is the average of strategy i, r_{f} is the risk-free rate sourced from Kenneth R. French website, and σᵢ is the standard deviation of the strategy i, which represent its total volatility (mba.tuck.dartmouth.edu/pages/faculty/ken.french/Data_Library/f-f_5_factors_2×3.html; which is hereby incorporated by reference herein in its entirety). The Sharpe ratio, a preferred tool for discerning relationships between signals and market movements, aligns with objective 1, as it indicates better risk-adjusted performance, facilitating the comparison of diverse investment strategies based on both their returns and volatility. Both scholars and industry professionals use the Sharpe ratio to assess and rank investments based on their return to risk tradeoff. This facilitates informed investment and portfolio management decisions. This aids in crafting informed investment choices and more effective portfolio management. It should be noted that the Sharpe ratio has limitations, in that it implicitly assumes normal distribution, sensitive to risk-free rate, focuses only on volatility as risk, lacks consideration of skewness and kurtosis, and can be time dependent. Complementary metrics are needed for a comprehensive evaluation.

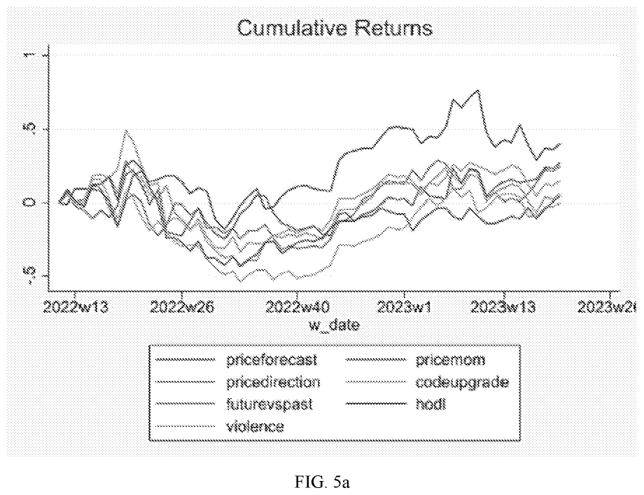

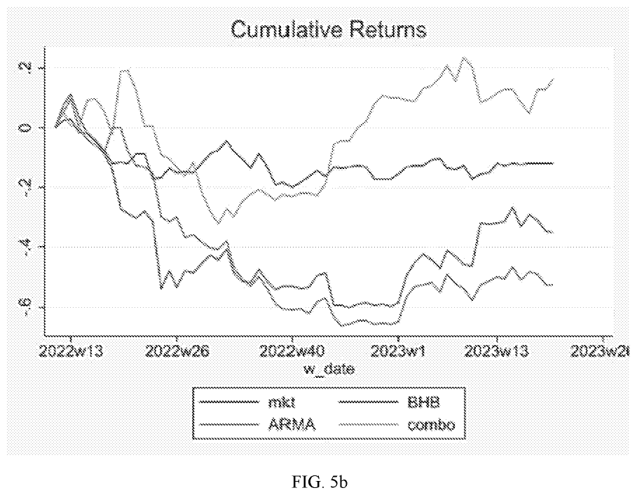

Besides exhibiting the highest Sharpe ratios, these seven signals are uniquely positioned among the 55 tested, with the comprehensive inputs derived from diverse sources, emphasizing objective 2. They are the only ones that generated positive cumulative returns during the sample timeframe. Although numerous signals outperform the chosen benchmarks, this natural threshold was adopted to underscore the efficacy of the empirical design of embodiments of the subject invention. Consequently, price forecast (priceforecast), price momentum (pricemom), price direction (price_direction), code upgrade (codeupgrade), future versus past (futurevspast), HODL (hodl), and violence (violence) were selected, as illustrated in FIGS. 5a and 5b.

The test sample, capturing the dual memory dynamics in line with objective 3, covers the out-of-sample predictions, spans from Mar. 20, 2022, to May 18, 2023. FIGS. 5a and 5b showcase the cumulative returns of daily-rebalanced long-short bitcoin portfolios. Specifically, FIG. 5a displays the cumulative returns driven by the top seven signal-based long-short BTC strategies (abbreviated as LSB) listed above. FIG. 5b displays a comparison of the cumulative returns of the combo strategy with three benchmarks: the naive buy-and-hold bitcoin strategy (BHB), the aggregate returns of the US equity market defined by Fama et al. (sourced from Kenneth French's data library) and abbreviated as MKT), and the autoregressive moving average (ARMA thereafter) model strategy (see also Fama et al., Common risk factors in the returns on stocks and bonds, J. Financ. Econ. 33 (1) (1993) 3-56; which is hereby incorporated by reference herein in its entirety). MKT is the value-weighted return of all firms incorporated in the Center for Research in Security Prices (CRSP) database and listed on the NYSE, AMEX, or NASDAQ appropriately filtered as described on Kenneth French's website (mba.tuck.dartmouth.edu/pages/faculty/ken.french/Data_Library/f-f_5_factors_2×3.html). The combo strategy is constructed from equally weighting the cumulative returns of the top seven LSB strategies. By consolidating the top seven signal indicators into a single composite metric, the strategy offers a streamlined presentation and simplifies the analysis of cumulative return plots. This approach, in turn, provides clear, actionable insights for investors, aligning with objective 4, as it enables a more straightforward evaluation than assessing each individual signal separately.

The naive BHB strategy acts as a fundamental benchmark for evaluating the combo strategy's performance. This approach entails buying bitcoin and holding the position throughout the sample period. Comparing the combo strategy to the BHB benchmark highlights the advantages of the signal-based approach of embodiments and its potential to outperform passive investment strategies.

MKT serves as the second benchmark, facilitating a comparison of the combo strategy's performance with broader equity market trends. Through this comparison with the MKT benchmark, the capability was determined for the signal-based method of embodiments to yield returns outperforming the general equity market. The third benchmark employed is the ARMA model, a widely used statistical tool for time series data analysis and forecasting. The ARMA model's “Autoregressive” (AR) component captures the relationship between the current value of the series and its past values, whereas the “Moving Average” component (MA) models the dependency on past error terms. This dual-component nature enables the ARMA model to effectively capture and predict time series patterns. ARMA models are used as a benchmark for predicting BTC returns because they capture time-dependent patterns and volatility in historical data, allowing for more accurate forecasts and evaluation of potential investment opportunities.

In the training sample, various ARMA models were estimated with distinct lag combinations, and then the Akaike Information Criterion (AIC) was used to evaluate model fit (see also Akaike, Information theory and an extension of the maximum likelihood principle, in: Selected papers of Hirotugu Akaike, 1998, pp. 199-213; which is hereby incorporated by reference herein in its entirety). The model exhibiting the lowest AIC value is considered optimal, balancing model complexity with explanatory strength (see also Akaike, A new look at the statistical model identification, IEEE Trans. Autom. Control 19 (6) (1974) 716-723; which is hereby incorporated by reference herein in its entirety). Thus, the ARMA (3,3) model was selected based on this criterion (see also Cavanaugh, Unifying the derivations for the Akaike and corrected Akaike information criteria, Stat. Probab. Lett. 33 (2) (1997) 201-208; which is hereby incorporated by reference herein in its entirety).

### Example 2

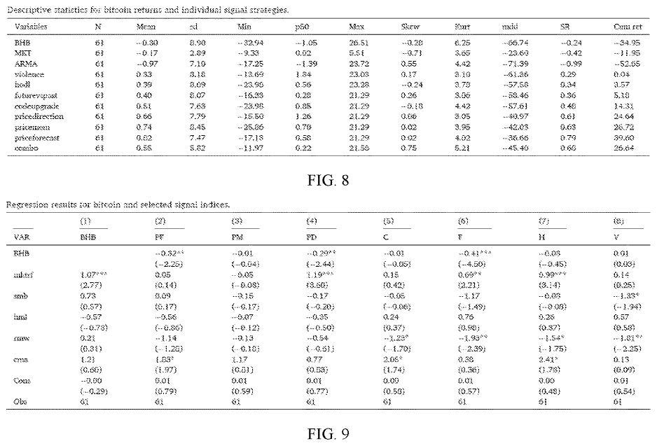

The table in FIG. 8 presents an in-depth examination of the returns from the LSB strategies, offering both detailed descriptive statistics and a comprehensive evaluation against the BHB, MKT, and ARMA benchmarks. The table in FIG. 8 showcases the equally weighted returns of the seven individual LSB strategies, combined under the ‘combo’ label. All eight LSB strategies, including the combo, demonstrate superior performance across various measures.

From Mar. 20, 2022, to May 18, 2023, while the BHB, MKT, and ARMA benchmarks posted negative cumulative returns of −34.95%, −11.95%, and −52.65% respectively due to a challenging macroeconomic landscape, all seven LSB strategies delivered positive cumulative returns, as illustrated in FIG. 5a. They also consistently outperformed all three benchmarks in terms of cumulative return. Notably, the price forecast (priceforecast) strategy delivered the highest cumulative return of 39.60% with a Sharpe ratio of 0.79. Further emphasizing the consistency and reliability of our findings, FIG. 5b showcases the substantial positive cumulative return of 26.64% by the combo strategy, accompanied by a Sharpe ratio of 0.68.

Beyond standard metrics like cumulative returns, the LSB strategies' Sharpe ratios, a pivotal metric in assessing the excess return-to-risk tradeoff, stand out. In particular, their Sharpe ratios exceed those of the BHB (−0.24), MKT (−0.42), and ARMA (−0.99) benchmarks. Given the significance of the Sharpe ratio in both financial academia and practice, these positive ratios underscore that the LSB strategies offer a more favorable balance between return and risk in comparison to the benchmarks.

Each of the eight LSB strategies exhibits maximum drawdowns (mdd) with absolute values ranging from −36.66% to −61.36%, which are less severe than those of the BHB (−66.74%) and ARMA (−71.39%) benchmarks. However, the equity market benchmark (−26.60%) sees even milder fluctuations. These statistics underscore the LSB strategies' resilience and capacity to reduce downside risk. Notably, a diminished maximum drawdown suggests reduced crash risk. Given the notoriously high volatility of the cryptocurrency asset class, having a strategy resilient to crash risk is essential.

The shape of return distributions, as measured by skewness, underscores the reduced downside risk of the LSB strategies. Skewness helps gauge the likelihood of extreme returns, with higher skewness indicating rarer large weekly return losses. While the LSB strategies have higher skewness than the BHB (−0.28) and MKT (−0.71) benchmarks, they exhibit less skewness compared to the ARMA's skewness (0.55). The apparent contradiction between skewness and mean return can be puzzling. This difference arises from comparing the asymmetry in the return distribution, as indicated by skewness, with the general average performance represented by the mean return. In strategies with pronounced negative mean returns, the distribution might lean towards extreme negative outcomes, thus boosting skewness, even if the mean return is low or negative.

Conversely, strategies with higher mean returns generally have a more balanced return distribution. These positive returns lead to a distribution that leans towards symmetry, producing a reduced skewness value. This underscores the distinct roles of skewness and mean return: while skewness captures the asymmetry of returns, the mean return reflects the strategy's overall performance. Moreover, all eight LSB strategies show reduced kurtosis in comparison to the BHB strategy, pointing to fewer extreme values and outliers in returns. A lower kurtosis is typically preferred by risk-averse investors because it indicates a decreased likelihood of extreme results. Relative to the BHB strategy, the LSB strategies exhibit a more stable risk-return profile, appealing to investors with a preference for lower volatility. Excluding the combo strategy, all LSB strategies have a lower kurtosis than the ARMA benchmark. Though there is not a clear advantage in kurtosis for the LSB strategies against the MKT benchmark, their kurtosis values being less than the BHB's further attest to their minimized downside risk. In essence, the reduced kurtosis in the LSB strategies reinforces their appealing risk profile.

### Example 3

Delving deeper into the financial performance of the LSB strategies, the table in FIG. 9 showcases their risk-adjusted returns, derived from time series ordinary least squares (OLS) regression. This analysis, which aligns with objective 1, encompasses signal-driven strategies such as price forecast (PF), price momentum (PM), price direction (PD), code upgrade (C), future vs past (F), HODL (H), and violence (V), while controlling for specific proxies of systematic risk. The factors controlling for risk encompass the naive BHB excess returns and the Fama/French five research factors sourced from Kenneth French's database-market excess returns (mktrf), size (smb), book-to-market (hml), conservative minus aggressive (cma), and robust minus weak (rmw) (see also French et al., A five-factor asset pricing model, J. Financ. Econ. 116 (1) (2015) 1-22; which is hereby incorporated by reference herein in its entirety). The t-statistics, presented in parentheses, employ Newey and West standard errors with a two-lag specification. Portfolios undergo daily rebalancing (see also Newey et al., Hypothesis testing with efficient method of moments estimation, Int. Econ. Rev. (1987) 777-787; which is hereby incorporated by reference herein in its entirety).

Column (1) in the table in FIG. 9 presents the regression outcomes when BTC excess returns are mapped against the Fama/French five-factor model. The primary coefficient of concern is the one tied to market excess returns (mktrf). This coefficient gauges the sensitivity of the BHB strategy's returns to overall equity market fluctuations. A pronounced coefficient implies a stronger covariance between the strategy's returns and market movements, whereas a diminished coefficient points to lesser market dependance. The coefficient associated with market excess returns (mktrf) is both positive (1.07) and exhibits high statistical significance (t-stat=2.77). This underscores a meaningful covariance between BTC and equity market excess returns, furthering the understanding of the relationship between informational signals and market fluctuations, as emphasized by objective 1. Simply put, a market excess return of +1% prompts a corresponding bitcoin excess return of +1.07%, and the converse holds true. This regression lays the groundwork for a deeper exploration of individual LSB strategy regressions.

Columns (2)-(8) in the table in FIG. 9 outline the regression outcomes for individual LSB strategies when mapped against the BHB strategy, factoring in the Fama/French five risk factors. Among these, four LSB strategies (PF, PM, C, V) reveal no statistically significant coefficients for equity market excess returns (mktrf), denoting an absence of significant covariance or correlation with the equity market. These observations, particularly on the potential diversification advantages and risk mitigation of various strategies, provide actionable insights in line with objective 4, enabling investors to make informed decisions for consistent market outperformance. Conversely, the other three LSB strategies (PD, F, H) exhibit positive and statistically significant coefficients in relation to equity market returns (mktrf). Nevertheless, the coefficients for F (0.69) and H (0.99) are of lesser magnitude than the BHB strategy, indicating lower co-movements with the equity market and decreased systematic risk. In contrast, the PD strategy's coefficient (1.19) exceeds that of the BHB strategy in magnitude.

The regression coefficients for the BHB strategy across all signals either show statistically significant negative values or hover near zero with statistical insignificance (columns (2)-(8)). These outcomes indicate that the signal-driven trading strategies either maintain a negative correlation or lack any significant correlation with the BHB strategy. This observation points to potential diversification advantages for a portfolio. Incorporating the signal-driven strategies in conjunction with the BHB strategy might help in lowering the overall portfolio risk. Given the independent or inverse correlation of these strategies, their performance might not always follow the same direction as the BHB strategy. Such dynamics provide risk mitigation during times when the BHB strategy performs well and serve as a diversifying hedge when signal-driven strategies underperform.

Strategies with uncorrelation or negative correlation, when integrated into a portfolio, enhance risk-adjusted returns and reduce volatility. The BHB's negative coefficient emphasizes the benefit of blending these strategies with a Buy and Hold Bitcoin approach. While the LSB strategies consistently outperform benchmarks, this research, aligning with objective 1, offers not only in-depth market dynamics but also delivers actionable insights for investors, capturing the essence of objective 4.

### Example 4

Pursuing objective 2, which emphasizes comprehensive inputs from various sources, multi-signal strategies were delved into, generating a total of 120 combined signals. This was achieved by integrating every possible combination of the seven chosen individual signals into the LSTM algorithm. These combinations yielded a variety of mixed signals such as (PD, PM, PF), (V, H), (V, PD), and (V, H, C, PD, PM, PF), among others. Here, PD, PM, PF, V, H, C, and F represent price direction, price momentum, price forecast, violence, HODL, code upgrade, and future versus past, respectively. Highlighting the actionable insights as prioritized in objective 4, combinations that achieved over 100% in cumulative return during the sample period were focused on. The results also highlight a weighted average return of the top 14 performing combined signals, termed ‘combo’, and a blend of all 55 signals, designated as ‘mix55’. In alignment with objective 1's aim to discern relationships between signals and market movements, the predictive efficacy of individual signals was assessed in comparison to three benchmarks-BHB, MKT, and ARMA. The combined signals were further categorized according to five primary groupings from the MarketPsych Analytics indices-Emotional, Price, Factual, General, and Slang. Unlike the seven signals detailed in Example 1, signals within these categories were not pre-selected based on performance metrics. The analysis encompassed a spectrum of performance metrics across various prediction groups in relation to the benchmarks (BHB, MKT, and ARMA), providing critical insights into their predicting power and implications for decision-making. The following groups were examined: a) mixed signals ((PD, PM, PF), (V, H, V, PD), (V, H, C, PD, PM, PF), (V, H, PD, PM), (V, H, C), (H, C), (V, H, C, PM), (V, H, C, PD, PM), (V, H, C, PM, PF), (V, F, C, PF), (H, F, C, PM), (V, C, PF), (V, F, C, PM, PF)); b) the Emotional, Price, Factual, General, and Slang MarketPsych Analytics indices; and c) the mix55 predictor that includes all signals.

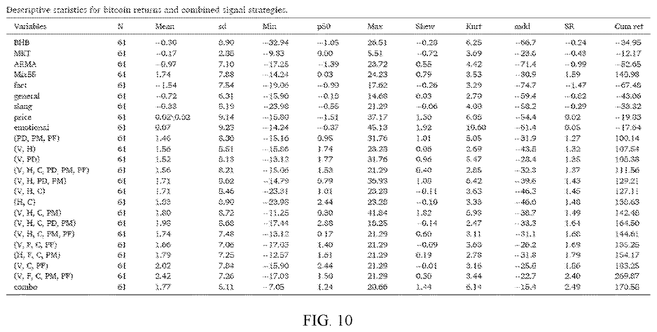

The table in FIG. 10 presents an examination of the returns from the mixed signal strategies. Aligned with objective 4 and objective 1, this analysis reveals the intricacies of how these signals correlate with market movements by presenting both detailed descriptive statistics and a comprehensive evaluation against the BHB, MKT, and ARMA benchmarks. Within the prediction groups, the mixed signals exhibit a higher Sharpe ratio relative to the BHB, MKT, and ARMA benchmarks. The indices for Price and Emotional combinations outperform the benchmarks in performance, highlighting their potential to achieve high risk-adjusted returns. Moreover, the ‘mix55’ predictor, encapsulating all 55 signals which tie back to objective 2's call for comprehensive inputs, showcases an enhanced Sharpe ratio when juxtaposed with the benchmarks, marking its robust risk-adjusted performance.

Subsequently, the measures of skewness and kurtosis were calculated, shedding light on the distributional nature of the investment returns. In line with objective 3's focus on capturing both real-time sentiments and historical patterns, both the composite signals and the MarketPsych Analytics indices—Factual, General, Slang, Price, and Emotional—manifest return distributions that diverge from the normal distribution. This deviation is observable from their skewness and kurtosis values, which differ from zero and three, respectively, pointing to asymmetric returns and the existence of a leptokurtic distribution in returns. In contrast, the benchmarks present more subdued skewness and kurtosis values, suggesting they lean towards a normal distribution.

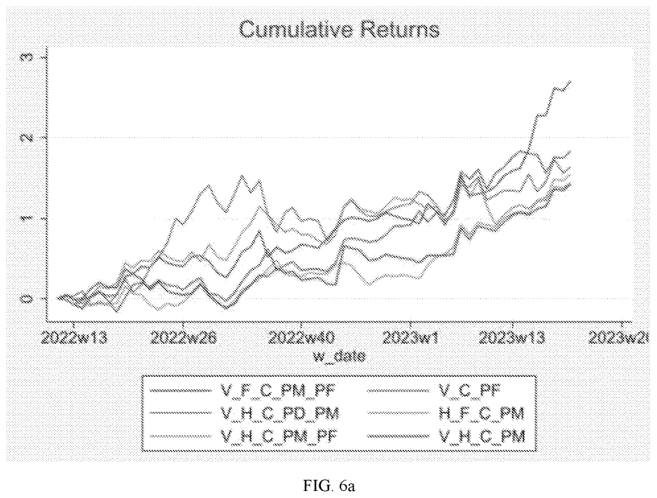

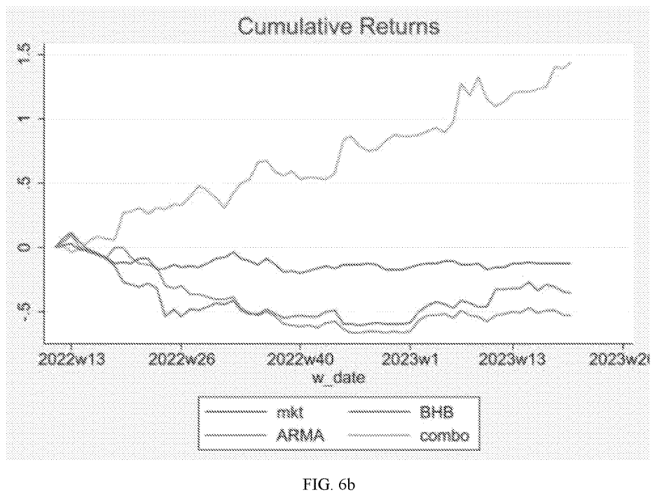

Additionally, the maximum drawdown (mdd) serves as an essential measure, quantifying the most substantial decline in an investment's value from its peak to its subsequent low point. Within the prediction groups, the mixed signals, as well as the Factual, General, Slang, Price, and Emotional indices, show diminished maximum drawdown values compared to the benchmarks. Reflecting the actionable insights of objective 4, these findings suggest that employing these prediction groups might limit exposure to downturns, thus better preserving capital when contrasted with the benchmarks. Finally, cumulative returns serve as an intuitive yet robust metric, offering a holistic perspective on the investment's performance across the studied interval. The 55 mixed signals, along with the Factual, General, Slang, Price, and Emotional categories, surpass the benchmarks in cumulative returns. FIG. 6a illustrates the cumulative returns of the top six mixed signals. The results also emphasize the weighted average return of the top 14 performing combined signals, presented as ‘combo’ in FIG. 6b, showcasing their potential for substantial investment gains.

An analysis of the performance metrics shows that prediction groups-including mixed signals, Factual, General, Slang, Price, and Emotional indices-exhibit favorable characteristics when benchmarked against BHB, MKT, and ARMA. These groups not only report enhanced Sharpe ratios but also demonstrate diminished maximum drawdowns alongside augmented cumulative returns. Reinforcing the actionable insights outlined in objective 4, such observations underscore the potential these prediction groups hold in refining decision-support frameworks for bitcoin investments.

### Example 5

In alignment with objective 1's directive to unravel the relationship between signals and market movements, a comparative analysis between the selected mixed signals and the group indices (Emotional, Price, Factual, General, Slang) was undertaken, employing the same financial metrics in the table in FIG. 10. Notably, the selected mixed signals persistently surpassed the combined indices across diverse metrics. In particular, the mixed signals showcased more favorable average and cumulative returns relative to each of the seven individual signal indices. Further, the mixed signals achieved high Sharpe ratios, reflecting objective 4's focus on actionable insights by indicating a better risk-reward tradeoff. Concurrently, these signals displayed reduced maximum drawdown values, indicating better protection against potential losses.

The analysis underscores the enhanced performance of pre-selected mixed signals vis-a-vis mean return, cumulative return, Sharpe ratio, maximum drawdown, and distribution features. The data further confirms that these mixed signals outperform both combined and individual signal indices in predicting higher returns. Echoing the overarching theme of objective 1, the validity of the predictive method of embodiments of the subject invention is further strengthened by these observations. The consistent superiority of the preselected mixed signals compared to the combined and individual indices suggests that their standout financial performance is not merely due to chance. In light of objective 4's pursuit of actionable insights, these results emphasize the efficacy of the predictive method of embodiments of the subject invention in producing top-tier predictive signals for informed bitcoin investment decisions.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A system for decision support for trading cryptocurrency, the system comprising:
a processor; and
a machine-readable medium in operable communication with the processor and having instructions stored thereon that, when executed by the processor, perform the following steps:
i) receiving first time-series data comprising prices of a cryptocurrency;
ii) receiving second time-series data comprising a plurality of index signals, each index signal of the plurality of index signals being derived from a market index based on at least one of a news source and a social media source;
iii) integrating the first time-series data and the second time-series data to give an integrated dataset;
iv) utilizing a long short-term memory (LSTM) neural network on the integrated dataset to give output comprising predicted prices of the cryptocurrency;
v) generating a first portfolio based on the predicted prices of the cryptocurrency, the first portfolio comprising first market signals regarding the cryptocurrency; and
vi) providing the first market signals to the LSTM neural network and repeating steps iv) and v) at least one time, with the LSTM neural network also utilizing the latest first market signals in each repeated step iv), to generate a final portfolio based on the latest predicted prices of the cryptocurrency, the final portfolio comprising final market signals regarding the cryptocurrency,
the first market signals comprising a plurality of combinations of first market signals, and
the final market signals comprising a subset of the plurality of combinations of first market signals.

2. The system according to claim 1, the instructions when executed further comprising:
vii) providing investment recommendations to a user based on the first portfolio.

3. The system according to claim 1, the cryptocurrency being Bitcoin.

4. The system according to claim 1, the first market signals comprising price forecast (PF), price momentum (PM), price direction (PD), code upgrade (C), future versus past (F), HODL (H), and violence (V).

5. The system according to claim 4, the plurality of combinations of first market signals comprising combinations of PF, PM, PD, C, F, H, and V.

6. The system according to claim 5, the plurality of combinations of first market signals comprising 120 combinations of PF, PM, PD, C, F, H, and V.

7. The system according to claim 1, the plurality of combinations of first market signals comprising 120 combinations.

8. The system according to claim 7, the plurality of index signals comprising at least 55 index signals.

9. The system according to claim 1, the LSTM neural network comprising two LSTM layers and two dropout layers.

10. The system according to claim 1, further comprising a display in operable communication with at least one of the processor and the machine-readable medium,
the instructions when executed further comprising:
viii) displaying the first portfolio on the display.

11. A method for decision support for trading cryptocurrency, the method comprising:
i) receiving first time-series data comprising prices of a cryptocurrency;
ii) receiving second time-series data comprising a plurality of index signals, each index signal of the plurality of index signals being derived from a market index based on at least one of a news source and a social media source;
iii) integrating the first time-series data and the second time-series data to give an integrated dataset;
iv) utilizing a long short-term memory (LSTM) neural network on the integrated dataset to give output comprising predicted prices of the cryptocurrency; and
v) generating a first portfolio based on the predicted prices of the cryptocurrency, the first portfolio comprising first market signals regarding the cryptocurrency; and
vi) providing the first market signals to the LSTM neural network and repeating steps iv) and v) at least one time, with the LSTM neural network also utilizing the latest first market signals in each repeated step iv), to generate a final portfolio based on the latest predicted prices of the cryptocurrency, the final portfolio comprising final market signals regarding the cryptocurrency,
the first market signals comprising a plurality of combinations of first market signals, and
the final market signals comprising a subset of the plurality of combinations of first market signals.

12. The method according to claim 11, further comprising:
vii) providing investment recommendations to a user based on the first portfolio.

13. The method according to claim 11, further comprising:
viii) displaying the final portfolio on a display.

14. The method according to claim 11, the cryptocurrency being Bitcoin.

15. The method according to claim 11, the first market signals comprising price forecast (PF), price momentum (PM), price direction (PD), code upgrade (C), future versus past (F), HODL (H), violence (V), and combinations of PF, PM, PD, C, F, H, and V.

16. The method according to claim 15, the plurality of combinations of first market signals comprising combinations of PF, PM, PD, C, F, H, and V.

17. The method according to claim 16, the plurality of combinations of first market signals comprising 120 combinations of PF, PM, PD, C, F, H, and V.

18. The method according to claim 11, the plurality of index signals comprising at least 55 index signals.

19. The method according to claim 11, the LSTM neural network comprising two LSTM layers and two dropout layers.

20. A system for decision support for trading cryptocurrency, the system comprising:
a processor;
a display in operable communication with the processor; and
a machine-readable medium in operable communication with the processor and having instructions stored thereon that, when executed by the processor, perform the following steps:
i) receiving first time-series data comprising prices of a cryptocurrency;
ii) receiving second time-series data comprising a plurality of index signals, each index signal of the plurality of index signals being derived from a market index based on at least one of a news source and a social media source;
iii) integrating the first time-series data and the second time-series data to give an integrated dataset;
iv) utilizing a long short-term memory (LSTM) neural network on the integrated dataset to give output comprising predicted prices of the cryptocurrency;
v) generating a first portfolio based on the predicted prices of the cryptocurrency, the first portfolio comprising first market signals regarding the cryptocurrency;
vi) providing the first market signals to the LSTM neural network and repeating steps iv) and v) at least one time, with the LSTM neural network also utilizing the latest first market signals in each repeated step iv), to generate a final portfolio based on the latest predicted prices of the cryptocurrency, the final portfolio comprising final market signals regarding the cryptocurrency;
vii) providing investment recommendations to a user based on the final portfolio; and
viii) displaying the final portfolio on the display,
the first market signals comprising a plurality of combinations of first market signals,
the final market signals comprising a subset of the plurality of combinations of first market signals,
the cryptocurrency being Bitcoin,
the plurality of combinations of first market signals comprising combinations of price forecast (PF), price momentum (PM), price direction (PD), code upgrade (C), future versus past (F), HODL (H), violence (V), and combinations of PF, PM, PD, C, F, H, and V, and
the LSTM neural network comprising two LSTM layers and two dropout layers.
